(19) United States
(12) Patent Application Publication
(10) Pub. No.: US 2016/0122001 A1
(43) Pub. Date: May 5, 2016

(54) ELECTRONIC FLIGHT CONTROLS WITH PARALLEL PROCESSED TORQUE & POSITIONING FOR PILOT OR ASTRONAUT TOUCH FEEDBACK

(71) Applicant: Robert Dennis Kennedy, Honolulu, HI (US)

(72) Inventor: Robert Dennis Kennedy, Honolulu, HI (US)

(21) Appl. No.: 14/530,722

(22) Filed: Nov. 1, 2014

(51) Int. Cl. B64C 13/12; G06F 9/46; B64C 13/18; B64C 13/20; B64C 13/22

(52) U.S. Cl. CPC B64C 13/12; B64C 13/20; B64C 13/22; B64C 13/18; G06F 9/46

(57) ABSTRACT

Cockpit controls designed for a at least two pilots and automation. Duplications of controls: sticks and control columns move along the same position path in unison with other sets of controls electronically based on a plurality of parallel processed parameters allowing two pilots to assist each other effectively with the ability of one pilot to override the other for effective monitoring and control in normal and emergency situations.

### FIELD OF THE INVENTION

This invention relates to flight control systems and spaceflight control systems and the redundancy and sensor feedback given to the pilot or astronaut by stick motion, position and force felt in the finger tips and hand of the pilot or astronaut when an automated system is controlling the craft or another crew-member manipulates the controls or an independent system tries to shake the stick or move the stick to warn the pilot.

### BACKGROUND OF THE INVENTION

Many so called “fly-by-wire” transport category prior-art dual control aircraft have controls that do not move in unison and do not transmit by feel the manipulation of the controls by one pilot to the other pilot or control surface aerodynamic deflection force or the auto-pilot or automation moving the controls or control surfaces, or warning systems that transmit warnings through feel in the stick or control column. In the case of two pilots with their hands on the controls at the same time the pilot applying the greater force does not override the other pilot. Button presses or procedural steps including call outs are necessary to transfer control or to override the other stick defeating an important redundancy that previously existed on even the earliest aircraft. Additionally when an auto-thrust system is changing settings many transport category aircraft have thrust levers that are not moved by automation so the additional instant redundant feedback for engine control settings by feel has been lost and only can be seen by latent instrument movement of thrust settings in the pilots visual frame of reference.

A large number of prior art transport category aircraft flying today force the pilot to use his sense of vision much more to make up for loss of touch feedback. Whoever is at the controls can only convey what is being done with the stick to the other pilot visually and/or aurally and not by feel in the other pilots controls (other pilots fingers and hands). Methods of warning the pilot of imminent danger through feel exist on many aircraft flying today except for a large number of so called “fly by wire” transport category aircraft. The prior art stick shaker and stick pusher methods of warning the pilot through feel of a problem have been discarded. Therefore the aircraft can be said to be less automated in this respect causing added work for the pilots especially in emergency situations and especially to find out what automation may be doing. In many emergent situations such as cockpit display failure, smoke in the cockpit, or unreliable sensor/instrument indications the pilot who would normally not have to speak about control position must talk to the other pilot creating extra chatter. In the case of automated flight neither control stick moves at all nor do the thrust levers on many transport category aircraft flying today.

Resultant instrument readings that must be used in place of the sense of touch is not trivial in providing instant sensory information used by the pilot to have awareness of the status of the aircraft and control positions. Earliest aircraft had cables to transmit control movement by one pilot to the other pilot via movements in both sticks or control columns and aerodynamic forces were also transmitted to the sticks or yoke and control column giving instant awareness of the status of the aircraft and control positions. Additionally the thrust levers, rudder pedals and in the case of turbo-props power levers, and propeller levers used cables or other mechanical mechanisms to indicate commanded values by their position. Feedback to the pilot what commanded values were set could easily be felt by the position of the levers. Auto-thrust systems moved the thrust-levers and in the case of the autopilot the yoke and control columns were moved indicating by feel what the current commanded position or setting was.

More widespread use of compact multiprocessor devices and their increased availability has made the application of multiprocessing to many applications much less expensive and compact and facilitates real time parallel computation of vector dot products to apply motion and torque to computer controlled electromagnets to directly drive the motion and maintain the position of a shaft on the end of a gimbal.

In view of these disadvantages and advantages this invention addresses this lack of redundancy in many modern transport category aircraft in flight today and to carry forward the redundant safety feature built into some of the earliest aircraft flown with the earliest art cable linked control systems which allowed feedback to the pilot through feel to indicate control movements by the other pilot, aerodynamic forces or the computer/automated flight control system actions via a robust and cost effecting parallel computing electronic means.

### SUMMARY OF THE INVENTION

A stick with a universal joint mounted on its base to maintain a planar sheet parallel to the floor but able to move freely translating the motion input at the top of the stick. Up the shaft a gimbal is mounted at a fixed location which allows the motion to translate to the lower guide plate housed below and clear of the pilot's hand.

The stick assembly described above is combined with a parallel real time computer controlled system that moves the stick to a precise position electronically with a specific torque, speed, acceleration or deceleration and position path with the use of electromagnetic chain links of a chain forming a Traction Catenary and magnetic or electromagnetic beads strung on a wire or tether which also provide traction. As the auto-pilot flies the aircraft or a pilot flies the aircraft the other pilot is given feel that indicates what the autopilot or other pilot is doing rather than only seeing it collaterally by instrument changes. Aerodynamic control force is also added to the stick feel. Augmented feel is also provided by Feel Fingers which can communicate to the pilot heading information and a bracelet which fits around the shaft of the stick which tilts to warn the pilot.

### BRIEF DESCRIPTION OF THE DRAWINGS

The foregoing and other objects and advantages of the invention will become more clear with reference of the following detailed description as illustrated by the drawings in which:

FIG. 1 is a schematic diagram of a parallel stick control computing system showing the combined stick controller and other elements according to this invention

FIG. 2 is a flow diagram of a procedure for each stick control processor

FIG. 3 is a cutaway of an elementary electrical and mechanical parts according to this invention

FIG. 4 is a view of an X and Y coordinated motion drive of an embodiment of this invention which uses chains of electromagnets called Traction Catenaries and an advantaged pulley system

FIG. 5 is an embodiment of the invention which uses three spokes of Traction Catenaries to directly drive shaft movement

### DETAILED DESCRIPTION

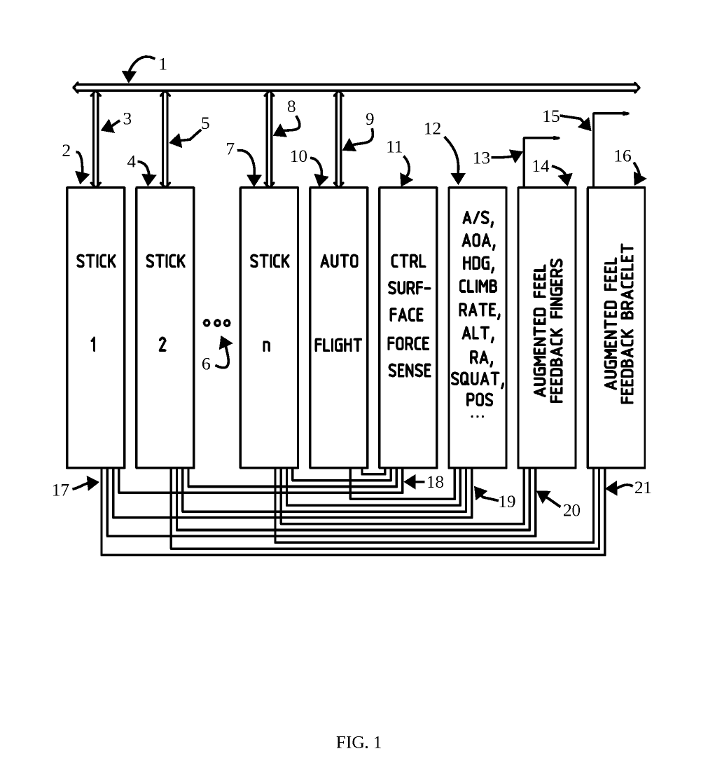

FIGS. 1 through 5 detail a simple parallel computing environment with accompanying mechanical assembly and parallel computerized electronic control according to this invention. Nevertheless, this description should be considered to apply to any type of lever or stick or control column and yoke. Other generalized adaptations include electronic gimbal applications wherein precise positioning with strong position holding and redundant position encoding and control over torque and acceleration and velocity of shaft or other movement is required.

FIG. 1 details a schematic diagram of a parallel computing method embodied by this invention to control all stick parameters and movement within 1 ms or less with a goal of less than 700 ns wherein each stick has essentially a black box 2, 4, and 7 or however many are in the system 6. Each black box has its own processing units and takes as input: sensor information 11 from the control surfaces 18, the automated flight control system or auto-pilot 10 via bus 9, other stick output 3, 5 and 8 via a bus or other broadcast method 1 which includes: torque, acceleration, deceleration, velocity, friction or holding force, the stick shaker, and the stick pusher. All flight parameters: pitot static airspeed, computed GPS based ground speed, barometric altitude, GPS altitude, vertical speed, magnetic heading, GPS ground track, temperature, altitude 12 are fed to each black box by discrete channels 19, ball left, ball right . . . . All of these signals are independently redundant with at least three other independent sensors and three independent and unique signal paths 17 and wherever possible independently written algorithms and sense methods are used in each redundant system. A voting method is used to flag and throw out any possibly failing sensor or sensor signal path. An Augmented Feel Feedback Bracelet is used to warn the pilot through feel of a near stall condition and is used to warn the pilot through feel by pushing the pilot's hand forward when an imminent stall is sensed. Augmented Feel feedback Fingers 14 have independent sensor input 13 and the Augmented Feel Feedback Bracelet 16 has independent input 15 as well. The Augmented Feel Feedback Fingers and Augmented Feel Feedback Bracelet are independent systems which feed directly 20 and 21 into the stick black boxes 2, 4, and 7 or however many are in the system 6.

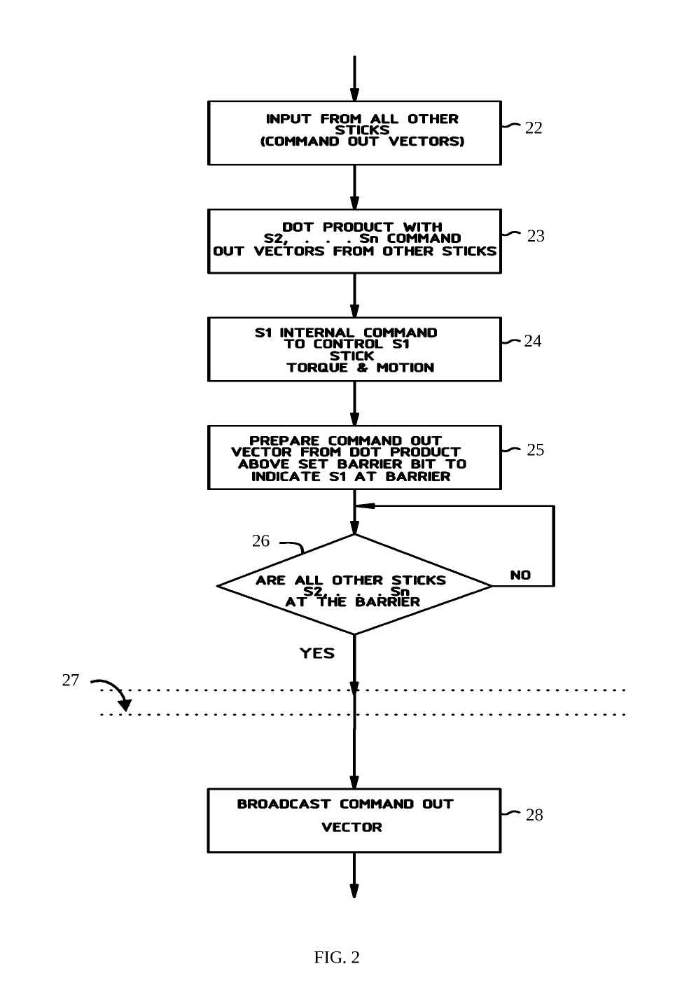

FIG. 2 details a flow diagram of a parallel processed procedure for each stick control processor. Each black box acquires all of the parameters (described by their respective command out vector) 22 and performs a dot product 23 of the individual stick command direction and force to produce a command for its own stick 24 which it rapidly executes. A new command out vector for the individual stick is prepared 25. This point in time is a synchronization point wherein all stick black boxes 26 wait at a barrier until all others have reached a point wherein all individual stick black boxes are ready to issue a stick command. This is the synchronization barrier 27. This command produces the appropriate acceleration, velocity and torque and position path with corresponding induction of the electromagnets in each link of a system which produces traction by contracting or expanding or by the traction produced by magnetic beads or electromagnetic beads which are drawn laterally toward a magnetized material or electromagnet. Once all of the sticks have reached this barrier all black boxes are said to be in synchronization and broadcast their respective command out vectors 28. All of this happens in less than 1 ms. A provision is made wherein all sticks can revert to a constant friction force and an open loop dead joystick (which is much like what is used in normal operation of current “fly by wire” transport category aircraft today) configuration wherein stick torque and positioning electromagnetics are turned off and simple position encoding is used.

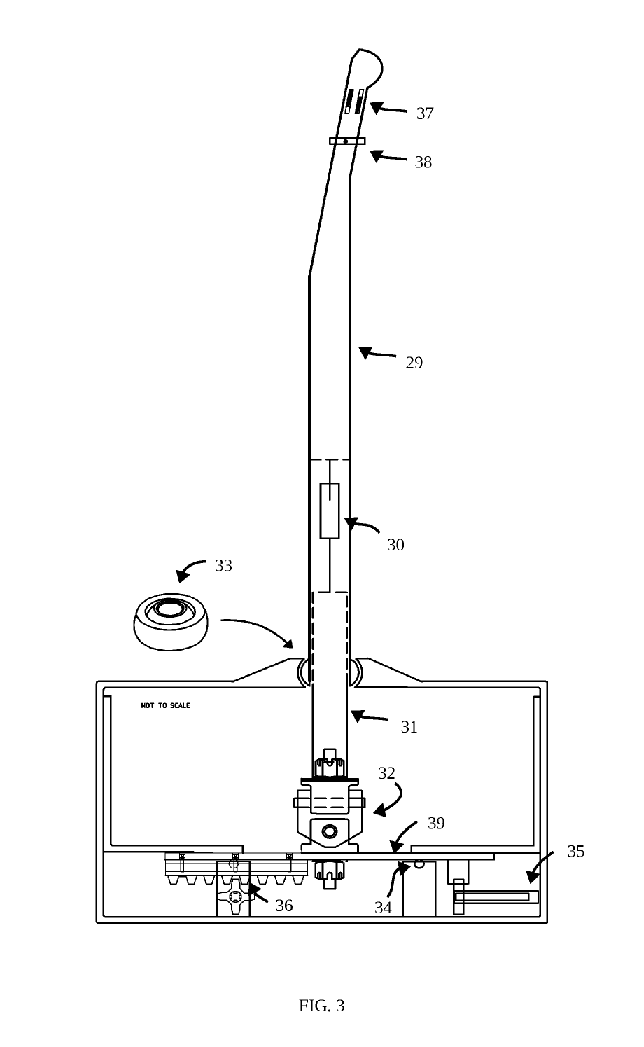

FIG. 3 details an embodiment of this invention with 37 Augmented Feel Feedback Fingers which communicate to the pilot via protruding out of openings in the shaft to indicate various information to the pilot as well as a Augmented Feedback Feel Bracelet 38 which tilts the lower part of the hand to indicate to the pilot of an impending dangerous situation. The bracelet is tilted up by the computer which tilts the pilots hand up encouraging him to pull back on the stick. The main stick 29 is secured to the top of an enclosure with a spherical bearing 33 which allows a second shaft 31 to freely move up and down inside the enclosure where a universal joint 32 is secured to a plate 39 which limits motion to one plane via bearings 34. Motion is imparted upon the shaft via X 36 and Y rack and pinions with linear slides 35 to allow X motion along the Y axis and Y motion along the X axis.

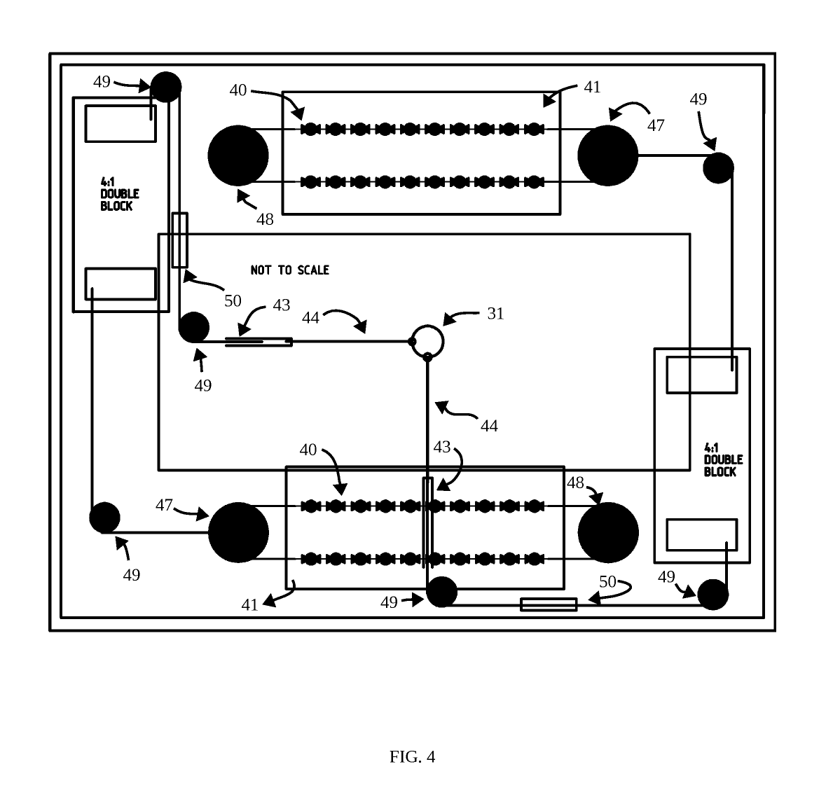

FIG. 4 details an embodiment of this invention with 40 Traction Catenary Pulley systems to drive X and Y coordinated motion where a fixed multiple grooved pulley 48 is connected to another pulley in simple loops to a second freely movable multiple grooved pulley 47. The Traction Catenary pulley systems squeeze together when current is induced via inducers 41 creating traction which in turn is advantaged by a 4:1 double block which in turn via a simple pulley 49 has a strain gauge 50 for each axis X and Y connected to a simple pulley 49 for pivot and a slide enclosed 43 control rod 44 which is connected directly to the load which is the second shaft of a concentric sliding conjugate shaft 31.

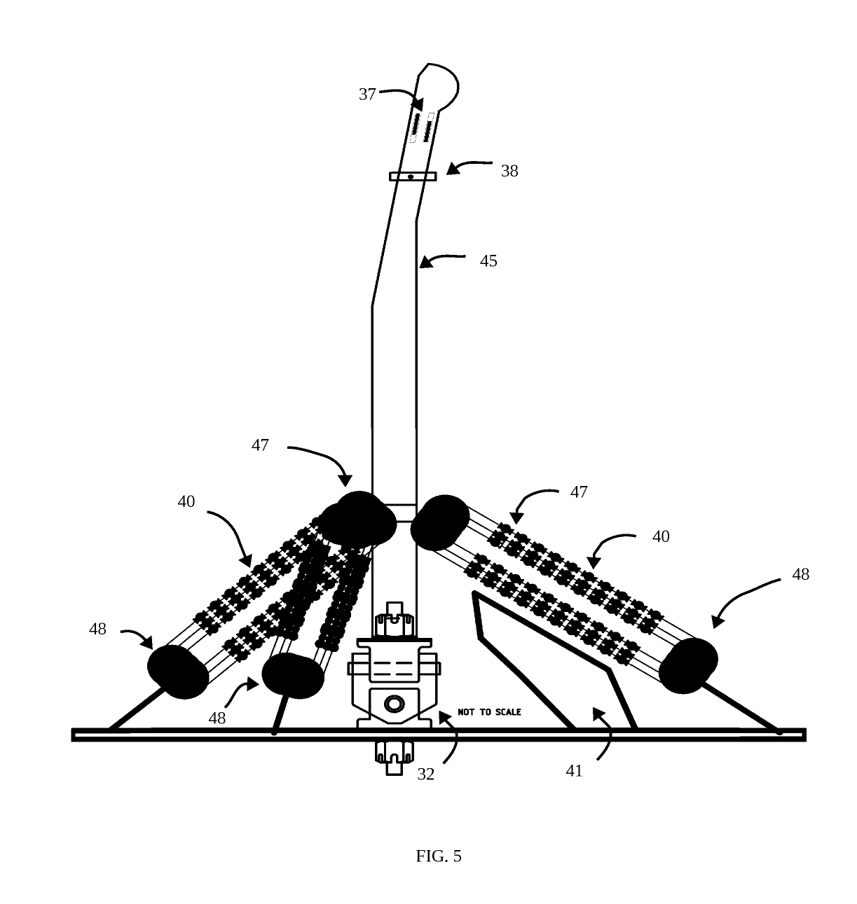

FIG. 5 details an embodiment of this invention wherein a universal joint 32 secures a single shaft 45 with Augmented Feel Feedback Fingers 37 and an Augmented Feel Feedback Bracelet 38 which is directly driven by 3 evenly place Traction Catenary 40 drive pulley systems with fixed pulleys 48 secured to the same plate as the universal joint each spaced at 120 degree radials wherein traction on the shaft is connected via the other non-fixed pulley 47 wherein inducers 41 (only one shown to avoid drawing clutter) are spaced at 120 radials below each Traction Catenary.

What I claim is:

1. A parallel computing mechatronic gimbal drive system specific to the operation of a plurality of parallel computing mechatronic gimbal drive systems communicating and working in parallel comprising a gimbal mechanism wherein a main shaft has a base secured to a spherical bearing wherein below the spherical bearing a base of a second concentric shaft can move freely up and down within the main shaft and protrudes out the base of the main shaft wherein at the base of the second shaft is a universal joint which is mounted to a moveable plate secured to single plane movement by bearings wherein the second shaft draws out or retracts into the main shaft when the main shaft is tilted in any direction within throw limits of the volume of an inverted cone with said moveable plate moving in the opposite direction along a plane of motion wherein a transduced strain gauge is secured to the main shaft and the second concentric shaft to read force with at least one instance of software execution wherein a software barrier provides the software instances of execution for each parallel computing mechatronic gimbal drive system a synchronization point in time in the parallel computation of a dot product by each parallel computing mechatronic gimbal drive system wherein each respective shaft is moved with a computed torque, acceleration, velocity and path to a precise position in synchronization or unison with at least one other similar mechatronic gimbal drive system wherein parallel computing rather than host computer control is used wherein the shaft can be moved robotically tracking specific positions along a specific path with a specific force and speed with a less than millisecond guaranteed parallel computation real time response with the ability of a user to grasp the shaft and manipulate it and with sufficient force to override the robotic positioning with normal human strength up to 200 lbs by a users hand wherein two independent parallel computing mechatronic gimbal drive systems used by two different users can either assist each other to push in the same direction or one user can overpower the other if necessary to position the two sticks in the same position wherein coordinated motion is made possible by X and Y rack and pinions wherein the racks are secured to the moveable plate with the X rack perpendicular to the Y rack wherein a pinion gear runs along the rack wherein the pinion gear is connected to a splined shaft which rides inside a mating splined cylinder allowing Y movement along an X axis with another similar rack and pinion mounted to the moveable plate allowing X movement along a Y axis wherein the splined cylinder, splined shaft and pinion gears are driven by electric motors.

2. A parallel computing mechatronic gimbal drive system specific to the operation of a plurality of parallel computing mechatronic gimbal drive systems communicating and working in parallel comprising a gimbal mechanism wherein a main shaft has a base secured to a spherical bearing wherein below the spherical bearing a base of a second concentric shaft can move freely up and down within the main shaft and protrudes out the base of the main shaft wherein at the base of the second shaft is a universal joint which is mounted to a moveable plate secured to single plane movement by bearings wherein the second shaft draws out or retracts into the main shaft when the main shaft is tilted in any direction within throw limits of the volume of an inverted cone with said moveable plate moving in the opposite direction along a plane of motion wherein a transduced strain gauge is secured to the main shaft and the second concentric shaft to read force with at least one instance of software execution wherein a software barrier provides the software instances of execution for each parallel computing mechatronic gimbal drive system a synchronization point in time in the parallel computation of a dot product by each parallel computing mechatronic gimbal drive system wherein each respective shaft is moved with a computed torque, acceleration, velocity and path to a precise position in synchronization or unison with at least one other similar mechatronic gimbal drive system wherein parallel computing rather than host computer control is used wherein the shaft can be moved robotically tracking specific positions along a specific path with a specific force and speed with a less than millisecond guaranteed parallel computation real time response with the ability of a user to grasp the shaft and manipulate it and with sufficient force to override the robotic positioning with normal human strength up to 200 lbs by a users hand wherein two independent parallel computing mechatronic gimbal drive systems used by two different users can either assist each other to push in the same direction or one user can overpower the other if necessary to position the two sticks in the same position wherein coordinated X,Y sensing and motion is provided by an X control rod attached to the base of the second shaft with a spherical bearing and a Y control rod attached to the base of the second shaft perpendicular to the X control rod with a spherical bearing wherein each control rod runs along a mating cylinder with splines with a wire rope secured to the end of the control rod with the wire rope running around a single pulley pivot point wherein the wire rope is directed at an up to a 90 degree turn to a strain gauge then a 4:1 mechanical advantage double block to a 1:1 two pulley system with multiple chains hung on a multiple grooved single pully to a second multiple grooved single pulley wherein the links of each chain electromagnetically contract when a current is induced (hereinafter referred to as a Traction Catenary) drawing the two pullies together wherein the more links in the chain the more contraction distance can be provided wherein the more grooves and chains added parallel to each other on the 2 pullies the more force can be provided wherein two pully systems of Traction Catenaries are used to drive two mechanically advantaged pulley systems for X and Y coordination.

3. A parallel computing mechatronic gimbal drive system specific to the operation of a plurality of parallel computing mechatronic gimbal drive systems communicating and working in parallel comprising a gimbal mechanism wherein a main shaft has a base secured to a spherical bearing wherein below the spherical bearing a base of a second concentric shaft can move freely up and down within the main shaft and protrudes out the base of the main shaft wherein at the base of the second shaft is a universal joint which is mounted to a moveable plate secured to single plane movement by bearings wherein the second shaft draws out or retracts into the main shaft when the main shaft is tilted in any direction within throw limits of the volume of an inverted cone with said moveable plate moving in the opposite direction along a plane of motion wherein a transduced strain gauge is secured to the main shaft and the second concentric shaft to read force with at least one instance of software execution wherein a software barrier provides the software instances of execution for each parallel computing mechatronic gimbal drive system a synchronization point in time in the parallel computation of a dot product by each parallel computing mechatronic gimbal drive system wherein each respective shaft is moved with a computed torque, acceleration, velocity and path to a precise position in synchronization or unison with at least one other similar mechatronic gimbal drive system wherein parallel computing rather than host computer control is used wherein the shaft can be moved robotically tracking specific positions along a specific path with a specific force and speed with a less than millisecond guaranteed parallel computation real time response with the ability of a user to grasp the shaft and manipulate it and with sufficient force to override the robotic positioning with normal human strength up to 200 lbs by a users hand wherein two independent parallel computing mechatronic gimbal drive systems used by two different users can either assist each other to push in the same direction or one user can overpower the other if necessary to position the two sticks in the same position wherein coordinated X,Y sensing and motion is provided by an X control rod attached to the base of the second shaft with a spherical bearing and a Y control rod attached to the base of the second shaft perpendicular to the X control rod with a spherical bearing wherein each control rod runs along a mating cylinder with splines with a wire rope secured to the end of the control rod with the wire rope running around a single pulley pivot point wherein the wire rope can be directed up to a 90 degree turn to a strain gauge then a 4:1 mechanical advantage double block to a 1:1 two pulley system with multiple tether/wire rope loops hung on a multiple grooved single pulley to a second multiple grooved single pulley wherein rare earth/neodinium beads/processor integrated and controlled electromagnetic beads are strung on the tether/wire rope wherein a conjugate computer controlled electromagnet inducer mounted external but nearby the strung beads which electromagnetically drawn at varying angles to an imaginary line between the centers of the two pullies causing varying force drawing the two pullies together providing a traction pull on the pulley system (hereinafter referred to as a Traction Bead Drive System) wherein two Traction Bead Drive Systems are used to drive two mechanically advantaged pulley systems for X and Y coordination

4. The parallel computing mechatronic gimbal drive system of claim 2 but rather than using two 1:1 two pulley systems with multiple Traction Catenary chains hung on a multiple grooved single pulley to a second multiple grooved single pulley for X and Y coordinated motion, at least one Traction Catenary in a tube with control rods at either end (hereinafter referred to as Traction Catenary Tendon Control Rods) are used for traction.

5. The parallel computing mechatronic gimbal drive system of claim 3 but rather than using two Traction Bead Drive Systems for X and Y coordinated motion, at least one set of magnetic or electromagnetic beads strung on a wire rope or tether with securing points at either end of the tether or wire rope end wherein an electromagnetic force is induced to draw the beads laterally at an angle up to perpendicular to pull the ends of the wire rope or tether together providing traction (hereinafter referred to as a Traction Bead Tendon Control Rod)

6. The parallel computing mechatronic gimbal drive systems of claims 1 through 5 wherein a plurality of protrusions extend out of openings in the top of the main shaft (hereinafter referred to as Augmented Feel Feedback Fingers) wherein these protrusions are a means of communication to the pilot or astronaut wherein the aircraft can indicate to the pilot an impending dangerous condition and communicate it to the pilot by feel wherein the aircraft can also communicate other information such as heading information wherein protrusions corresponding to 8 cardinal directions of a compass rose to indicate by feel a heading for navigation wherein at least one finger protrudes out while the others remain retracted to indicate a cardinal heading wherein various other items can be communicated in an encoded way such as a series or combinations of protrusions moving in an out in a series to indicate timely information such as power lines ahead, missile lock, minimums (MDA, DA, MAP, MVA, MSA, MEA), TCAS RA, missile tracking, airspeed, altitude, distance, missile evasion information navigation and precise heading information

7. The parallel computing mechatronic gimbal drive systems of claims 1 through 5 wherein a concentric ring fits over the main shaft and is tilted and moved up and down against the lower soft part of the hand near the pinky (hereinafter referred to as Augmented Feel Feedback Bracelet) communicating to the pilot to pull up (climb) by tilting upward or descend by tilting downward or an impending dangerous condition by raising the hand and by moving up or down to encode various problems or conditions of the aircraft/spacecraft wherein the aircraft/spacecraft can communicate morse code like messages to the pilot or astronaut various other items such as power lines ahead, missle lock, minimums(MDA, DA, MAP, MVA, MSA, MEA), TCAS RA, missle tracking, airspeed, altitude, distance, missle evasion information and precise heading information wherein the Augmented Feel Feedback Bracelet can also be used as feedback when moved by the pilot or astronaut

8. A parallel computing mechatronic gimbal drive system specific to the operation of a plurality of parallel computing mechatronic gimbal drive systems communicating and working in parallel comprising a shaft with a universal joint at the shaft base which is secured to a plate wherein at least half way down the shaft a set of at least 3 spokes on the shaft evenly spaced at 120 degrees protrude at up to a 90 degree angle for leverage as needed on the shaft wherein Traction Catenary pulley systems or Traction Catenary Tendon Control Rods are connected at these points or on the lever to positions on the plate

9. A parallel computing mechatronic gimbal drive system specific to the operation of a plurality of parallel computing mechatronic gimbal drive systems communicating and working in parallel comprising a shaft with a universal joint at the shaft base which is secured to a plate wherein at least half way down the shaft a set of at least 3 spokes on the shaft evenly spaced at 120 degrees protrude at up to a 90 degree angle for leverage as needed on the shaft wherein Traction Bead Drive Systems or Traction Bead Tendon Control Rods are connected at these points or on the lever to positions on the plate
